(19) United States
(12) Patent Application Publication
(10) Pub. No.: US 2016/0253702 A1
(43) Pub. Date: Sep. 1, 2016

(54) Location-Based Budget Alerts

(71) Applicant: EBAY, INC., San Jose, CA (US)

(72) Inventor: Sergio Pinzon Gonzales, JR., San Jose, CA (US)

(21) Appl. No.: 14/633,450

(22) Filed: Feb. 27, 2015

(51) Int. Cl. G06Q 30/02; H04W 4/02

(52) U.S. Cl. CPC G06Q 30/0249; H04W 4/023; G06Q 30/0261; G06Q 30/0267

(57) ABSTRACT

Systems, methods, and computer program products are disclosed for providing location-based budget alerts. A server receives location information from a mobile communications device for the mobile communications device. The server determines one or more stores that are within a determined vicinity of the mobile communications device. The server identifies at least one budget category for a user of the mobile communications device that is associated with the one or more stores. The server accesses information related to the budget category in an account associated with the user of the mobile communications device. The server then determines whether to transmit a budget notification to the mobile communications device that identifies the current status of the identified budget with respect to the current budget period. The budget notifications may provide a location dependent alert to notify the user before the user initiates a transaction at the store.

### BACKGROUND

1. Field of the Invention

The present disclosure generally relates to the determination of the geographic location of users and location-based budget alerts.

2. Related Art

Location-based services typically rely on the detection of a user's location (e.g., as detected by the user's satellite-based positioning system integrated in their phone or similar device) to provide tailored offers and other services based on location. These can include advertisements from local merchants to entice the user to visit their establishment as well as a variety of other services including automated payment based on location, automatic notifications, among others. These offers and services, however, do not take into account any budgetary constraints that the user may be under for any given reason.

Other services seek to assist the user in managing their finite resources by providing budgeting tools. These budgeting tools typically allow the user to divide up their existing resources, and/or anticipated resources in the coming budgetary cycle, into one or more discrete categories with target caps (e.g., clothing, groceries, bills, etc.). The user may be able to view amounts for one or more of the discrete categories when accessing the budgeting tool, or at the time of purchase of a product (e.g., where the budgeting tool is maintained by the user's chosen payment service provider such as PayPal to name an example).

However, the location-based services and budgeting tools above fail to provide a location-aware service that integrates budget constraints of users to the benefit of the users, local merchants, and/or associated payment providers.

### BRIEF DESCRIPTION OF THE FIGURES

FIG. 1 is a diagram of an exemplary wireless communications environment according to embodiments of the present disclosure.

FIG. 2 is a block diagram of an exemplary server according to embodiments of the present disclosure.

FIG. 3 is a block diagram of an exemplary mobile communications device according to embodiments of the present disclosure.

FIG. 4 is a diagram of an exemplary wireless communications environment according to embodiments of the present disclosure.

FIG. 5 is a diagram of an exemplary wireless communications environment according to embodiments of the present disclosure.

FIG. 6A is a flow diagram illustrating an embodiment of a method for location-based budget alerts at a server according to an embodiment of the present disclosure.

FIG. 6B is a flow diagram illustrating an embodiment of a method for location-based budget alerts at a mobile communications device according to an embodiment of the present disclosure.

FIG. 7 is a flow diagram illustrating an embodiment of a method for location-based budget alerts at a server according to an embodiment of the present disclosure.

FIG. 8A is a flow diagram illustrating an embodiment of a method for merchant-requested advertising based on location-based budget alerts according to an embodiment of the present disclosure.

FIG. 8B is a flow diagram illustrating an embodiment of a method for merchant-requested advertising based on location-based budget alerts according to an embodiment of the present disclosure.

FIG. 9 is a flow diagram illustrating an embodiment of a method for payment service provider location-based budget alerts according to an embodiment of the present disclosure.

FIG. 10 is a flow diagram illustrating an embodiment of a method for payment processor location-based budget alerts according to an embodiment of the present disclosure.

FIG. 11 is a flow diagram illustrating an embodiment of a method for online location-based browsing budget alerts according to an embodiment of the present disclosure.

FIG. 12 is a schematic view illustrating an embodiment of a computer system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present disclosure provides systems, methods, and computer program products for providing budget notifications/alerts to notify a user of available budget for a budget category associated with one or more nearby stores and/or for providing location-based notifications/alerts to a user based on available budget, before the user attempts to initiate or complete a transaction. For example, in an embodiment a user may maintain an account with a server that hosts embodiments of the present disclosure. The account may identify a mobile communications device that is associated with the user. As the user moves about with the mobile communications device, the mobile communications device may transmit updated location information of the mobile communications device. As the server receives the location information, it may periodically check whether any stores or other places of purchase are within a pre-defined vicinity to the mobile communications device or along a route of predicted travel for the user associated with the mobile communications device.

If there are any stores/places of purchase within the vicinity or along a route, the server may determine one or more budget categories that may fully or partially characterize the store (e.g., grocery, entertainment, clothing, etc.). The server may then access the account of the user for a corresponding budget category, and analyze the budget category to determine the current status. For example, the server may look at the total budget, the budget period, the amount spent already during the budget period, and/or an amount remaining (available) for the remainder of the budget period. The server may also determine one or more ratios associated with the budget information. The server then transmits this budget information, or some subset thereof, to the mobile communications device. The budget information may indicate that the user is near their budget limit with time still remaining, and therefore may want to avoid any purchase at the store. In some embodiments, the server may determine, based on the budget being near the limit, to instead block any message from being sent to the mobile communications device. If the budget information indicates that the user still has remaining budget and not much time left in the budget period, the budget information may indicate that the user may indulge in a purchase at the store without guilt of exceeding the budget set for that category.

In another embodiment, stores may utilize the service by requesting the server to locate nearby mobile communications devices and transmit one or more promotions to induce the user of each nearby mobile communications device to visit the store. For example, a store may send a request to the server and include a promotion and promotion parameters. The server may identify one or more mobile communications devices that are within a predefined range to the requesting store, as well as that meet one or more budget criteria included with the promotion parameters. The server may then transmit a budget notification targeted to those identified mobile communications devices (e.g., either by giving knowledge of their identities to the store or without giving knowledge of their identities to the store) and additionally include a promotional message identifying the store and/or some discount or special offer to induce the user of the mobile communications device to visit the store.

In yet another embodiment, payment service providers may utilize embodiments of the present disclosure in order to induce the user of the mobile communications devices to visit a store and make a purchase. Embodiments of the present disclosure may also be utilized during browsing sessions from various devices. While a subscribing user browses a merchant website, the server may receive information about the merchant website and identify a budget category associated with the merchant and/or website. The server can send a budget notification to the user to indicate whether the user should refrain from a purchase or may proceed without guilt, as described above, via some indication in the user's browsing session.

In this manner, embodiments of the present disclosure enable a personalized budget alert for users when coming within a vicinity (or browsing) of any stores, before reaching a point of sale to initiate or complete a purchase transaction.

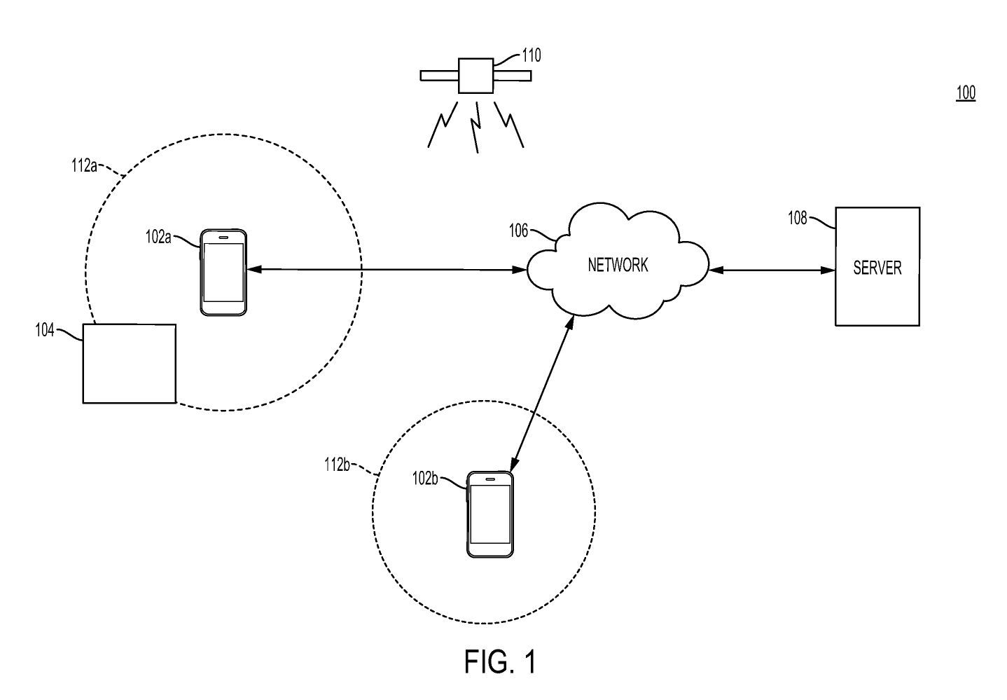

Referring now to FIG. 1, an embodiment of an exemplary wireless communications environment 100 is illustrated. The wireless communications environment 100 may include a number of mobile communications devices 102, one or more stores 104, one or more networks 106, one or more application servers 108, and global navigation satellite system (GNSS) 110. As will be recognized, the wireless communications environment 100 illustrated in FIG. 1 is simplified for sake of illustration.

The wireless communications environment 100 may support operation on multiple carriers (e.g., waveform signals of different frequencies). The wireless communications environment 100 may be a multi-carrier LTE network capable of efficiently allocating network resources. The wireless communications environment 100 is one example of a network to which various aspects of the disclosure apply. Other environments are also within the scope of the present disclosure, as will be recognized.

The wireless communications environment 100 includes one or more mobile communications devices 102, illustrated in FIG. 1 as mobile communications devices 102a and 102b. The mobile communications devices 102a/102b may be, for example, a User Equipment (UE). The mobile communications devices 102a/102b may each also be referred to as a terminal, a mobile station, a subscriber unit, etc. A mobile communications device 102 may be a cellular phone, a smartphone, a personal digital assistant, a wireless modem, a laptop computer, a tablet computer, etc., to name just a few examples.

The mobile communications devices 102a/102b may be location-aware, for example by including circuitry and/or software to enable the mobile communications devices 102a/102b to determine their own locations.

One exemplary embodiment of the mobile communications devices 102 is depicted in FIG. 3. In FIG. 3, the mobile communication devices 102 include a transceiver 302, a memory 304, a processor 306, a user interface 308, a data store 310, location determination system 312, and a budget alert module 314. These elements may be in direct or indirect communication with each other, for example via one or more buses.

The transceiver 302 may include a modem subsystem and a radio frequency (RF) unit and be configured to communicate bi-directionally with other devices, such as the network 106 and the server 108. The memory 304 may include a cache memory (e.g., a cache memory of the processor 206), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 304 includes a non-transitory computer-readable medium. The memory 304 may store instructions that, when executed by the processor 206, cause the processor 306 to perform the operations described herein in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor 306 may include a central processing unit (CPU), a digital signal processor (DSP), an application-specific integrated circuit (ASIC), a controller, a field programmable gate array (FPGA) device, another hardware device, a firmware device, or any combination thereof configured to perform the operations described herein and discussed in more detail below. The processor 306 may also be implemented as a combination of computing devices, e.g., a combination of a DSP and a microprocessor, a plurality of microprocessors, one or more microprocessors in conjunction with a DSP core, or any other such configuration. The processor 306 may be a single processor or multiple processors, where each processor may have one or more processing cores capable of parallel and/or sequential operation.

The user interface 308 may include an input component and an output component. For example, the user interface 308 may be a touch screen interface that outputs data for visual use as well as receives/processes one or more touches/swipes/gestures to implement a user command. For example, the user interface 308 may be used to display one or more budget alerts according to embodiments of the present disclosure.

The data store 310 may be, for example, a hard drive, flash drive, storage array, or other type of storage as will be understood by those skilled in the relevant art(s). The data store 310 may store budget information, location information, map information, and/or store information, alone (e.g., as an “app”) or in some combination with the server 108 as discussed below.

In an embodiment, the location determination system 312 may include one or more transceivers to enable communication with the GNSS 110 illustrated in FIG. 1. The GNSS 110 may be, for example, the Global Positioning System (GPS), Galileo, GLONASS, BeiDou, or some other such system that enables the mobile communications devices 102a/102b to determine geolocation information. The mobile communications devices 102a/102b may further include assisted-GPS for enhanced signal acquisition/location quality.

The budget alert module 314 may be an example of the app mentioned above with respect to the data store 310. In an embodiment, the budget alert module 314 is an application that communicates with the budget alert module 210 at the server 108. The budget alert module 314 may, for example, take the location information produced from the location determination system 312, together with other status information as necessary/useful, and transmit that information to the server 108 via the transceiver 302. The budget alert module 314 may also serve as a budget interface for the user of the mobile communications device 102, for example allowing the user to modify budget amounts, add/delete budget categories, modify pre-defined thresholds, and other aspects as would be recognized by those skilled in the relevant art(s). In an alternative embodiment, the budget alert module 314 may operate alone, e.g., without support from the server 108.

Returning to FIG. 1, with location information available to the mobile communications devices 102a/102b, it is possible to determine their vicinity to one or more stores 104. According to embodiments of the present disclosure, each mobile communications device 102a/102b may have a pre-defined vicinity 112a/112b (respectively) in which to identify any stores or other locations of interest. As illustrated in FIG. 1 as just one example, it is seen that the store 104 is within the vicinity 112a of the mobile communications device 102a, while there is no store within the vicinity 112b of mobile communications device 102b. The determination and/or updating of the vicinities 112a/112b will be described in more detail below with respect to subsequent figures.

The vicinity 112a/112b may be pre-defined with a default value that may be changed by the users of the mobile communications devices 102a/102b respectively. The vicinity 112a/112b may be, for example, set in terms of feet, meters, miles, or kilometers, to name just a few examples. In just one example, the vicinity 112a may be set to ½ mile as a pre-set or user-selected value. The vicinity 112a/112b may alternatively be set according to an automated process as assisted by one or more questions answered by users of the mobile communications devices 102a/102b (respectively) to guide the automated process. Questions may include, for example, a request for identification of how important the budget alerts may be to the user (ranked on a scale, for example), some general purchasing patterns of the user, typical traveling patterns, etc. The process may take the responses as inputs and output one or more suggestions of vicinity range and/or periodicity of alerts (e.g., each time within the vicinity of any given store 104, or just once a week, etc.).

In another embodiment, the vicinity 112a/112b may be set based on a predicted route of travel by the users of the mobile communications devices 102a/102b. For example, a predicted route may be based on a current direction and/or past direction of travel (e.g., based on information obtained from GNSS 110). The predicted route may also be determined based on a calendar associated with the user (and, e.g., is operated by the mobile communications devices 102) alone or in cooperation with the direction information. The route may further be predicted based on user history of travel (as tracked via the mobile communications devices 102), alone or in cooperation with any of the direction information and calendar information. As a result, the vicinity 112a/112b may be expanded in this embodiment to include not only stores that are within a specified radius, but also stores that are predicted to be close based on the predicted route.

Each of the mobile communications devices 102a/102b may communicate with other devices/systems/networks via the network 106. The network 106 may be, for example, a core network, an access network, other network, and/or any combination of networks as will be recognized. One or more of the mobile communications devices 102 may communicate with the server 108 using the network 106 via one or more base stations. For example, one or more the base stations may include an evolved Node B (eNodeB). A base station may also be referred to as a base transceiver station or an access point. It will be recognized that there could be one to many base stations, as well as be an assortment of different types such as macro, pico, and/or femto base stations. The base stations may communicate with the server 108 via the network 106, where the network is, for example, a backhaul core network. The base stations may also communicate with one another directly or indirectly, such as via network 106.

The server 108 may be a central server that the mobile communications devices 102 are attempting to communicate with. The server 108 may receive data as it is conveyed from the base stations 104 from one or more of the mobile communications devices 102, or directly from the mobile communications devices 102. The data may include, for example, location information as determined by the mobile communications devices 102, user input, or other information as will be recognized and discussed in more detail below with respect to subsequent figures. The server 108 may also transmit data, such as budget information, alerts, notifications, and requests for more information, to the mobile communications devices 102 directly or via the network 106.

For example, the mobile communications device 102a may periodically transmit its location information to the server 108, such that the server 108 determines that the mobile communications device 102 comes within the vicinity 112a of the store 104. The server 108 may make this determination based on other information available to it, such as a map it maintains (or that is maintained by a third party vendor), a database of participating locations, and/or other sources. In an alternative embodiment, the mobile communications devices 102 may maintain their own database and/or access a map to determine that a store 104 is within the predetermined vicinity 112a.

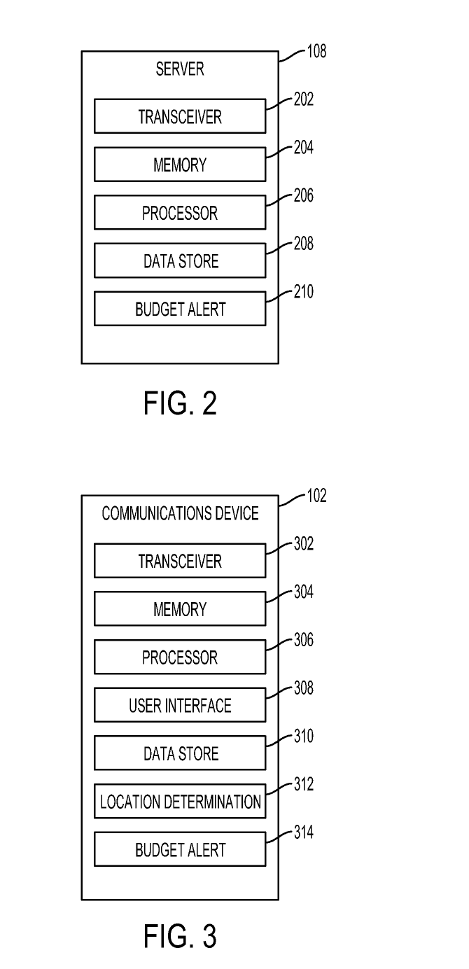

One exemplary embodiment of the server 108 is depicted in FIG. 2. In FIG. 2, the server 108 includes a transceiver 202, a memory 204, a processor 206, a data store 208, and a budget alert module 210. These elements may be in direct or indirect communication with each other, for example via one or more buses.

The transceiver 202, memory 204, and processor 206 may be similar to those features discussed above with respect to the transceiver 302, memory 304, and processor 306 of FIG. 3. In an embodiment, the memory 204 includes a non-transitory computer-readable medium. The memory 204 may store instructions that, when executed by the processor 206, cause the processor 206 to perform the operations described herein in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The data store 208 may be, for example, a hard drive, flash drive, storage array, or other type of storage as will be understood by those skilled in the relevant art(s). The data store 208 may house one or more databases for use, according to embodiments of the present disclosure, for storing budget information, location information, map information, and/or store information.

The budget alert module 210 may be an application that communicates with the budget alert module 314 at the mobile communications device 102. The budget alert module 210 may, for example, receive the location information produced from the mobile communications device 102, together with other status information from the mobile communications device 102. The budget alert module 210 may be a stand-alone application, e.g. with all necessary information maintained by a local database. Alternatively, the budget alert module 210 may interface with third-party budget/expenditure tracking services. The budget alert module 210 may periodically sync with any such third-party budget/expenditure tracking service according to a pre-defined interval, or alternatively on an as-needed basis (e.g., when receiving location information from a subscribing mobile communications device 102).

Returning again to FIG. 1, a user of each mobile communications device 102 that participates in embodiments of the present disclosure may maintain a budget. The budget may be a monetary budget for a fixed budget period and include one or more distinct or related categories. For example, a user of mobile communications device 102a may maintain a monthly budget with a few categories such as grocery, clothing, and entertainment to name just a few examples. These budgets may be stored either locally with the mobile communications device 102a (e.g., in data store 310), at the server 108 (e.g., in the data store 208), or some combination of the two. The budget categories may be changed (e.g., deleted, new ones added, etc.) as well as the targets modified (e.g., the budget amounts raised or lowered and/or budget period modified per user or other preference). In another embodiment, the budget may be an amount that includes all categories, i.e., simply an amount budgeted for a certain budget time period regardless of purchase types or categories.

According to embodiments of the present disclosure (using mobile communications device 102a for an example), when the mobile communications device 102a comes close enough to the store 104 such that the store 104 is within the vicinity 112a (either within a predetermined radius or predicted to be headed towards the store 104), the mobile communications device 102a may display a location-based budget alert. As one specific example, where the store 104 is a clothing store (and identifiable as such), and the user of the mobile communications device 102a has a clothing budget category, the mobile communications device 102a may display an alert on the mobile communications device 102a. As another example, the user of the mobile communications device 102a may have a budget category specific to the store itself such that an alert is generated based on the specific store, and not just any store that sells similar items. As another example, the user of the mobile communications device 102a may have a budget category specific to a particular brand, such that multiple locations (e.g., different stores or the same store at different locations) may fall within the category for potential alerts.

The alert is based on the current status of the user's clothing budget—e.g., when it is close to the start of the month with a relatively large percentage of the set clothing budget remaining, the alert may notify the user that there is a large amount remaining in the clothing budget, but that it is still near the beginning of the budget period. Alternatively, when it is in the middle of the budget period and a large percentage of the clothing budget has already been used, the alert may notify the user that they have used a large percentage of the budget and there is still a fair amount of time remaining in the budget period—suggesting that the user may be best advised to refrain from a purchase (or, at least, a larger-ticket purchase) at that time. Alternatively, if it is near the end of the budget period and there is still a large percentage of the budget remaining, the alert may notify the user that there is still a large percentage of budget remaining and that the user could indulge in a clothing purchase if so desired. As a further example, if the user is expected to make a large purchase in the future and within the budget period, the alert may notify that the user should forego any large purchases. As a result, according to embodiments of the present disclosure the user may receive, via the mobile communications device 102a, a personalized budget alert when coming within a vicinity 112a of any stores 104, before reaching a point of sale to initiate or complete a purchase transaction.

The particular percentage threshold at which the alert is triggered (e.g., for a small percentage remaining triggering an alert to refrain from purchases or a large percentage remaining triggering an alert that the user could indulge, etc.) may be set according to a predetermined amount, dynamically according to one or more system-determined algorithms, or by the users as mentioned above. These thresholds may be set independently from other parameters, or alternatively may be set in cooperation with parameters such as a time remaining in the budget period threshold and a threshold distance. For example, a system-determined algorithm may be based on the system analyzing the user's purchasing habits over a prior period of time (amount per budget period and/or timing of the amount over the budget period) to estimate what percentage threshold and/or timing threshold to set. As another example, the user of the mobile communications device 102 may modify the threshold(s) by interacting with the budget alert module 314.

The alert may simply be a notification of an offer or incentive for a store or item, based on the user's budget, without additional information about how much budget is remaining or other budgeting information. This provides the user a more concise alert, without information that the user may not need. In other words, the user is provided an alert/notification/incentive for a product and/or store because the service provider (e.g., server 108) has determined the user has sufficient budget to make such a purchase. On the other hand, if the service provider (e.g., server 108) determines that the user should not be making a purchase of a specific type, item, or from a specific store (e.g., based on the amount of budget remaining in the budget period), any such notifications that ordinarily may be delivered to the user would not be communicated to the mobile communications device 102.

Location-based budget alerts may be useful to not only the user of the mobile communications device 102, but also one or more of the stores 104 and a payment processor, as will be described according to the various embodiments below.

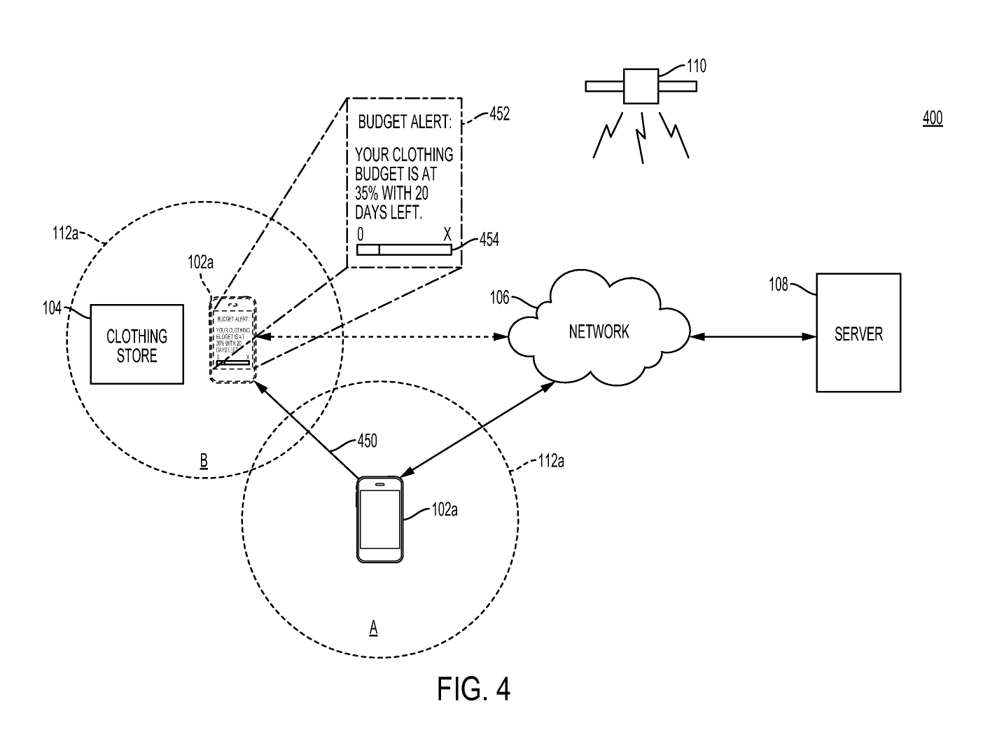

FIG. 4 is a diagram of an exemplary wireless communications environment 400 according to embodiments of the present disclosure. The wireless communications environment 400 illustrates an exemplary location-based budget alert for a user of a mobile communications device 102 (illustrated in FIG. 4, for simplicity of discussion, as mobile communications device 102a). The wireless communications environment 400 demonstrates a scenario in which the mobile communications device 102a moves from an area A that is not within vicinity 112a of any store 104, to area B that is within the vicinity 112a of store 104.

As shown, the mobile communications device 102a is initially at area A. While at area A, the mobile communications device 102a determines its location by communicating with GNSS 110, as described above with respect to FIG. 1. Once the mobile communications device 102a knows its location, a budget alert may be prepared. In embodiments where the server 108 is involved, the mobile communications device 102a may transmit the determined location information, alone or in combination with other relevant information, to the server 108 (e.g., via the network 106). The server 108 may take this location information and compare the location information (up to the boundary of the vicinity 112a) to store location information it maintains in a database or which it obtains from some third-party map or location source. The server 108 determines that there are no stores 104 within the vicinity 112a, and in an embodiment takes no further action with respect to the mobile communications device 102a.

As the mobile communications device 102a moves, it may periodically send updated location information as it becomes available, or according to a pre-determined (and modifiable) time and/or distance interval. Eventually, the mobile communications device 102a is in area B, where a clothing store 104 (as an illustrative example only) is within the vicinity 112a. In response to receiving the location information of the mobile communications device 102a while in area B, the server 108 determines that the clothing store 104 is within the vicinity 112a. In response, the server 108 determines the store 104's category(ies). This can be done by querying the store (e.g., via an online query), accessing information stored by a third party (e.g., a map application that maintains metadata regarding store type), accessing information stored and maintained locally (e.g., in data store 208, or some combination of the above or other alternatives.

Once the server 108 has the store 104's category, in this example clothing, the server 108 accesses an account associated with the user of the mobile communications device 102a (or just the mobile communications device 102a) to identify whether there is a particular budget set and maintained for that category. This may be performed, for example, by the budget alert module 210 described with respect to FIG. 2 above. If there is no particular budget set for that category (or categories, where the store has multiple different types of merchandise such as clothing and food, etc.), the server 108 may either take no further action (e.g., no alert transmitted to the mobile communications device 102a) or access a general or “miscellaneous” budget if there are user preferences set for such and notify the mobile communications device 102a of the current status of the general or “miscellaneous” budget.

If there is a particular budget set for the identified category, the server 108 determines what percentage of the budget has already been used within the budget period, as well as how much time is left within the budget period. For example, in FIG. 4 the server 108 may identify that the user's clothing budget is set for $200 of which 35% has already been spent (or $70), the budget period is 1 month, and there are 20 days left in the budget period. The server 108 may take this information, or some subset thereof, and transmit it to the mobile communications device 102a as budget alert 452. As just one example of how the information may be visualized to the user, e.g. via the user interface 308 described in FIG. 3 above, the budget alert 452 may illustrate the percentage of budget used versus total budget as bar graph 454. Many forms of communication/notification are envisioned as within the scope of the present disclosure. For example, the budget alert 452 may be in the form of a text message (e.g., SMS), app-based, or other alert-based notification. The budget alert 452 may include just budget category and amount information, just percentage information, just warning of exceeding the overall budget based on time of month, or any combination thereof.

In determining whether a budget alert 452 is necessary, the server 108 may be configured to take several different inputs into consideration. As already mentioned, the server 108 may take the store type into consideration. The server 108 may also be tied in to other databases maintained by or for the user, for example a purchase history database that can be used to identify purchasing trends by the user of the mobile communications device 102a at the particular store 104 (or, in addition or alternatively, for the budget category generally each budget period as well as throughout the budget period).

As a further example, in addition to identifying the overall budget category of the store (here clothing), in embodiments of the present disclosure the server 108 may be able to determine the type of clothing store including typical or average prices for inventory there. Thus, the budget alert may be tailored according to the predicted cost of the store to include a warning on whether the particular items in the store could push the user over their budget. For example, if the user enters a budget/discount clothing store, the server 108 may not warn the user that any purchases may push the user over the budget, because no products alone may cause that. In contrast, if the user enters an upscale/designer store, the server 108 may identify this and determine that any one (or predetermined number) purchase would push the user over their pre-determined budget amount for clothing.

In alternative embodiments, as indicated above, the budget alert 452 may be generated locally by the mobile communications device 102a (e.g., via the budget alert module 314 described above with respect to FIG. 3 above) as the mobile communications deice 102a. Alternatively, the mobile communications device 102a may use a hybrid of local and server-based alerting, for example depending upon whether a connection to the server 108 is available at any given point in time or not. Either way, under any of the above approaches a personalized budget alert 452 can be provided in a real-time manner when coming within a vicinity 112a of any stores 104, before reaching a point of sale to initiate or complete a purchase transaction.

In an alternative embodiment, instead of automatically sending location information as it is determined by the mobile communications device 102a, the mobile communications device 102a may send the location information to the server 108 on demand, e.g. by accessing the budget alert module 314 and pressing a button to manually request a budget alert notification. In response, the server 108 may operate as described above, and either return a budget alert notification if there is a store 104 within the vicinity 112a, or a short communication indicating that there are currently no stores within range. In this way, the user of the mobile communications device 102a may still receive personalized budget alerts prior to reaching a point of sale to initiate or complete a purchase transaction while retaining increased control over the periodicity and timing of the alerts.

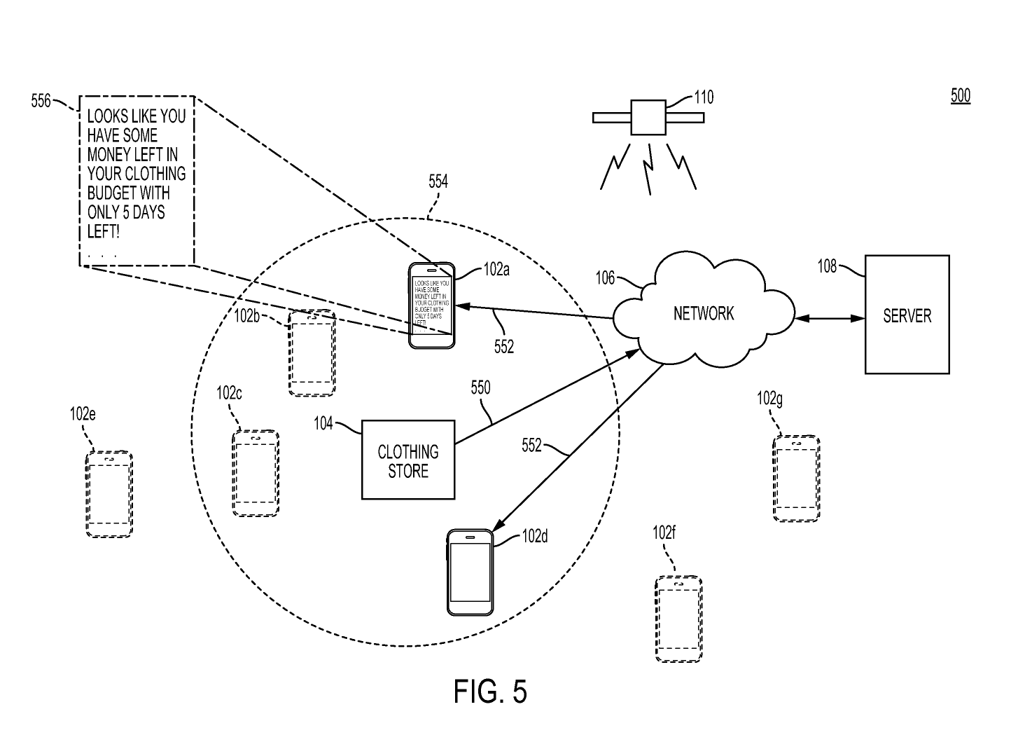

Turning now to FIG. 5, an exemplary embodiment of a wireless communications environment 500 is shown according to embodiments of the present disclosure. The wireless communications environment 500 illustrates an exemplary location-based budget alert intended for one or more mobile communications devices 102 that can be beneficial for the merchant(s) operating the store(s) 104 (illustrated in FIG. 5, for simplicity of discussion, as single clothing store 104).

As shown in FIG. 5, a plurality of mobile communications devices 102 (102a-102g) are within the environment 500. The merchant of store 104 may have subscribed to the services provided by the server 108, and submit a request to the server 108. Alternatively, the merchant of the store 104 may not have subscribed to a service, but rather send a one-off request to the server 108. Either way, the request may ask the server 108 to identify any mobile communications devices 102 that are within a pre-defined radius 554 of the store 104. The pre-defined radius 554 may be arbitrarily set by the server 108, previously have been set by the store 104, or be identified in the request sent by the store 104. In another embodiment, the pre-defined radius 554 may be set based on a predicted route of travel by the users of the mobile communications devices 102, similar to the discussion above with respect to FIG. 1. As a result, the pre-defined radius 554 may be expanded in this embodiment to include not only mobile communications devices 102 that are within a specified radius, but also mobile communications devices 102 that are predicted to be within range based on their predicted routes.

The request may further (or alternatively) request the server 108 identify any mobile communications devices 102 that have a budget category set within which the store 104 fits, and/or which have a certain percentage of budget remaining for that category. The server 108 may identify any matching mobile communications devices 102 (e.g., that are within the pre-defined radius and/or have a corresponding budget category) and send an offered advertisement/budget alert to the qualifying mobile communications devices 102 without disclosing any personal information to the merchant of the store 104, thus protecting the privacy of the individual users. Alternatively, the server 108 may identify the matching mobile communications devices 102 to the store 104 so that the store 104 may directly contact those mobile communications devices 102 with the advertisement.

In the example of FIG. 5, the merchant of the clothing store 104 sends a request 550 to the server 108 (via the network 106, for example) to identify mobile communications devices 102 that are within the radius 554, have a budget for clothing, and whose budget still remains above a specified threshold (e.g., greater than a specified % remaining or an absolute dollar amount). As shown, mobile communications devices 102a, 102b, 102c, and 102d are within the radius 554, while mobile communications devices 102e, 102f, and 102g are without the radius 554.

Of the mobile communications devices 102a, 102b, 102c, and 102d within the radius 554, the server 108 then identifies which mobile communications devices have a clothing budget and which have a remaining budget that exceeds the specified threshold still. In FIG. 5, those which meet the criteria are shown in solid lines while those which do not in dashed lines. As shown, mobile communications devices 102a and 102d have remaining budget above the specified threshold while mobile communications devices 102b and 102c do not.

Based on this determination, the server 108 transmits a budget alert/advertisement message 552 to each of the mobile communications devices 102a/102d, which are shown on the mobile communications devices 102a/102d as budget alerts 556. For example, the budget alert 556 may be a disguised advertisement, e.g. a budget alert sent to the qualifying mobile communications devices 102a/102d to notify them that they have sufficient money remaining in their clothing budget to indulge in a clothing purchase during that clothing period, including identifying that the store 104 is nearby.

Taking the example of FIG. 5 a step further, the store 104 may further coordinate with the server 108 in order to provide specific incentive(s) to the qualifying mobile communications devices 102a/102d in an attempt to induce the user of the mobile communications devices 102a/102d to visit the store 104.

In one example, the store 104 may include, as part of its request 550, one or more predetermined incentives for any users' mobile communications devices 102 that are within the radius 554, for example one or more sales occurring at the store 104 that day or targeted for nearby persons.

In another example, the store 104 may include, as part of its request 550, one or more parameters for what incentive(s) may be crafted to specifically target the qualifying mobile communications devices 102a/102d. This may include, for example, a discount amount or range available for one or more specific products or product categories, as well as how long the discount or promotion may be valid for. In one embodiment, the store 104 may correspond with the server 108 to craft a specific incentive, with the store 104 retaining final say on whether an incentive is transmitted to the qualifying mobile communications devices 102a/102d as part of the budget alert/advertisement message 552. In an alternative embodiment, the store 104 may send the parameters to the server 108 allow the server 108 to craft specific incentives to be sent as part of the budget alert/advertisement message 552.

In an embodiment, the crafting of a specifically targeted promotion may include identifying mobile communications devices 102 that exceed the predefined remaining budget limitation. The crafting of the specifically targeted promotion may offer to discount the price for one or more items sold by the store 104 to increase the possibility of inducing the user of the mobile communications devices 102 to visit the store 104 to make a purchase while potentially remaining within a limited remaining budget amount. As with the embodiments above, the server 108 may refrain from disclosing identifying information of specific users to the store 104 (e.g. by sending the promotion to identified candidates from the server 108) or alternatively may identify candidates to the store 104 so the store 104 may directly contact those mobile communications devices 102 with the specifically targeted promotion (tailored advertisement).

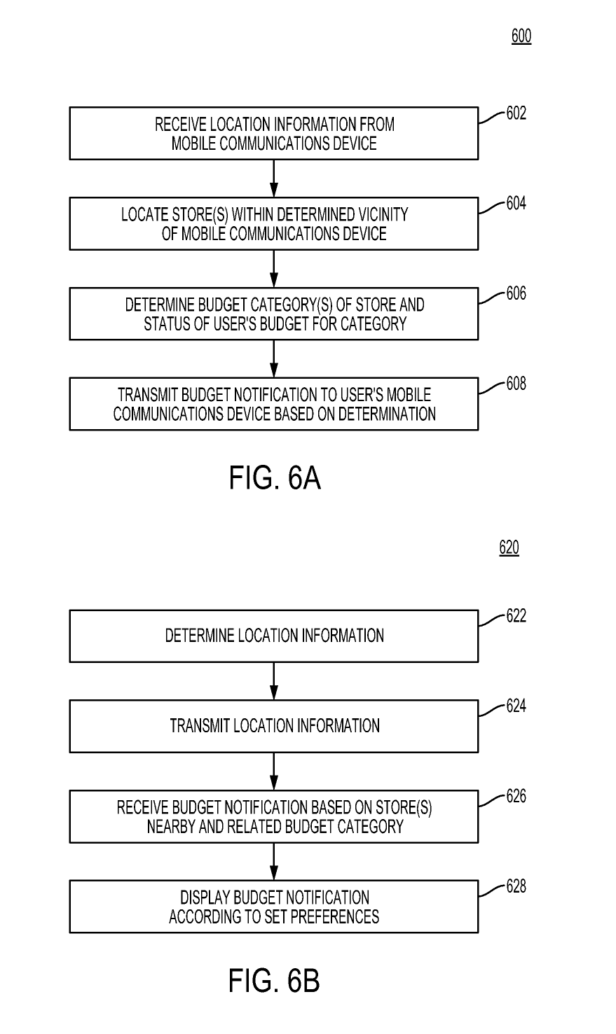

FIG. 6A is a flow diagram illustrating an embodiment of a method 600 for location-based budget alerts at a server according to an embodiment of the present disclosure. For example, the server may be server 108 as discussed with respect to the embodiments above. The method 600 will be described with respect to a specific mobile communications device 102 for simplicity of discussion, though it will be recognized that the aspects described herein may be applicable to a plurality of mobile communications devices 102. It is understood that additional steps can be provided before, during, and after the steps of method 600, and that some of the steps described can be replaced or eliminated for other embodiments of the method 600.

At step 602, the server 108 receives location information from a mobile communications device 102. The location information may be, for example, GPS location data that the server 108 receives via transceiver 202 as generated by the mobile communications device 102 in communication with a GNSS 110.

At step 604, the server 108 locates one or more stores (e.g., store 104 as illustrated in the examples above) that are within a determined vicinity of the mobile communications device 102's current location (e.g., illustrated as vicinity 112 in FIG. 4 above and/or predicted route placing the mobile communications device 102 within the vicinity 112). The server 108 may accomplish this, for example, by checking a local database it maintains or by querying a third party, such as a map application or stores specifically, or some combination of the above. If there are no stores within the vicinity 112, the method 600 may end and the server 108 waits for another message with new location information from the mobile communications device 102.

If there are one or more stores 104 that are within the vicinity 112, the method 600 proceeds to step 606. At step 606, the server 108 (for example, using budget alert module 210) determines one or more budget categories associated with each store 104. The server 108 then checks whether the user associated with the mobile communications device 102 has created a category in their budget particular to the budget category associated with the store 104. If not, then the server 108 may, in embodiments, alternatively turn to a miscellaneous or general category instead, or just end method 600 and wait for another message. With the determined budget category, the server 108 checks the status of the budget category for the user—e.g., an amount available still in the budget, a comparison to the overall budget (e.g. calculation of a percentage), and how much time is left in the budget period.

At step 608, the server 108 takes this information it has determined and transmits the information, or some subset/summary thereof, to the mobile communications device 102 associated with the user's account. This information is transmitted to the mobile communications device 102 as a budget notification, and includes some or all of the information determined in the previous steps. As a result, the server 108 sends a personalized budget alert to the mobile communications device 102 when coming within a vicinity 112a of any stores 104, before reaching a point of sale to initiate or complete a purchase transaction.

FIG. 6B is a flow diagram illustrating an embodiment of a method 620 for location-based budget alerts at a mobile communications device according to an embodiment of the present disclosure. For example, the mobile communications device may be mobile communications device 102 as discussed with respect to the embodiments above. The method 620 will be described with respect to a specific mobile communications device 102 and server 108 for simplicity of discussion, though it will be recognized that the aspects described herein may be applicable to a plurality of mobile communications devices 102. It is understood that additional steps can be provided before, during, and after the steps of method 620, and that some of the steps described can be replaced or eliminated for other embodiments of the method 620.

At step 622, a mobile communications device 102 determines location information corresponding to its current geographic location. For example, the mobile communications device 102 may communicate with a GNSS 110 in cooperation with the location determination system 312 described with respect to FIG. 3 above.

At step 624, the mobile communications device 102 transmits the location information determined from step 622 to the sever 108. In embodiments where the server 108 is not involved, step 624 involves passing the location information on to the budget alert module 314 for local analysis/budget determination.

At step 626, the mobile communications device 102 receives, in response to its prior transmission of location information at step 624, a budget notification that is based on one or more stores that have been identified to be within the vicinity 112 (as illustrated in FIG. 4 above) of the mobile communications device 102 and a corresponding budget category.

At step 628, the mobile communications device 102 displays the received budget notification, for example via the user interface 308 described with respect to FIG. 3 above. The budget notification may be displayed according to one or more previously determined preferences. For example, the budget notification may be displayed no matter what the user may be doing with the mobile communications device 102 at the time of receipt. Alternatively, the mobile communications device 102 may simply alert the user of a new message/notification via a light or icon. As another alternative, the mobile communications device 102 may hold the budget notification a fixed period of time, or a fixed distance (e.g., a fixed reduction in the distance between the mobile communications device 102 and the store(s) 104 identified in the budget notification).

The budget notification may identify, for example, that a large percentage of the budget has already been spent with more than a negligible amount of days remaining in the budget period. This may also include advice to scale spending back so as to not exceed the set budget. Alternatively, the budget notification may identify that a percentage of the budget less than a threshold has been spent, and/or that a small amount of days are remaining in the budget period, as well as a recommendation that the user may treat themselves to a purchase associated with the store 104's budget category(ies).

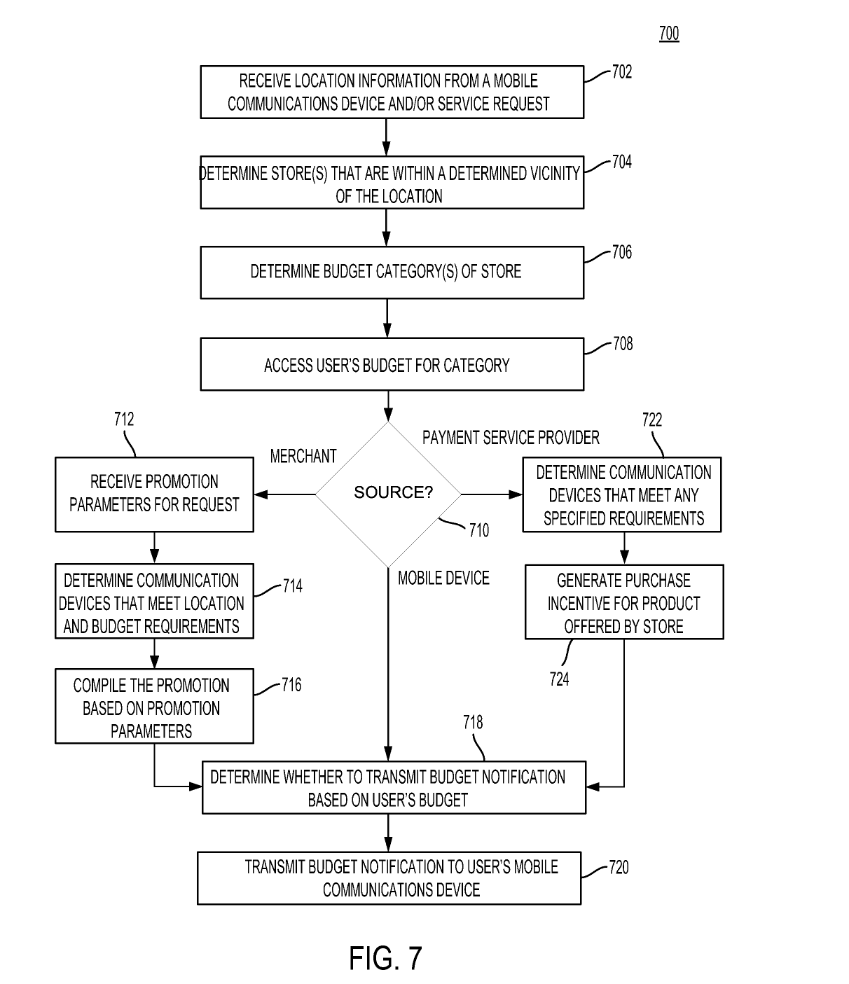

FIG. 7 is a flow diagram illustrating an embodiment of a method 700 for location-based budget alerts at a server according to an embodiment of the present disclosure. For example, the server may be server 108. It is understood that additional steps can be provided before, during, and after the steps of method 700, and that some of the steps described can be replaced or eliminated for other embodiments of the method 700.

At step 702, the server 108 receives location information from a mobile communications device 102 and/or a service request. For example, the server 108 may receive location information as described above with respect to step 602 of method 600. The service request may be from the mobile communications device 102 to receive the budget notification at step 720. This may be implicit in the receipt of the location information, implicit in a previously-set periodicity established by the user for the transmission of budget notifications, or a separate request that is sent with or separate from the location information. The service request may alternatively be from one or more stores 104, as discussed further below. The service request may alternatively be from one or more payment service providers, as discussed further below. Although mentioned in the singular, as will be recognized this can be the receipt of location information from multiple communications devices 102 and service requests from multiple communications devices 102, stores 104, and/or payment service providers.

At step 704, the server 108 determines one or more stores that are within a determined vicinity of the mobile communications device 102's current location, for example as described above with respect to step 604 of method 600.

At step 706, the server 108 determines one or more budget categories associated with each store 104 determined at step 704. This may be done, for example, as described above with respect to step 606 of method 600.

At step 708, the server 108 accesses the user's budget for the budget category. This may include, for example, accessing an amount available still in the budget, a comparison to the overall budget (e.g. calculation of a percentage), and how much time is left in the budget period. In an embodiment, this may also involve checking whether the user associated with the mobile communications device 102 has created a category in their budget particular to the budget category associated with the store 104. If not, then the server 108 may, in embodiments, alternatively turn to a miscellaneous or general category instead.

At decision step 710, the server 108 determines what the specific service request from step 702 is. If the server 108 receives an advertising request from a merchant of a store 104, the method 700 proceeds to step 712.

At step 712, the server 108 receives promotion parameters associated with the advertising request from the store 104. The promotion parameters may include, for example, a radius surrounding the store 104 (e.g., a predefined distance from the store 104), one or more specified budget categories, and/or a pre-defined percentage of budget remaining for the one or more categories for the budget period, as well as the promotion itself (including a price discount, free offering, door prize, etc.).

At step 714, the server 108 determines whether any communications devices 102 that have provided location information to the server 108 meet the location requirements (e.g. are within the specified radius), budget requirements (e.g., an associated budget category and within the pre-defined percentage of budget) for example as discussed above in the examiner of FIG. 5.

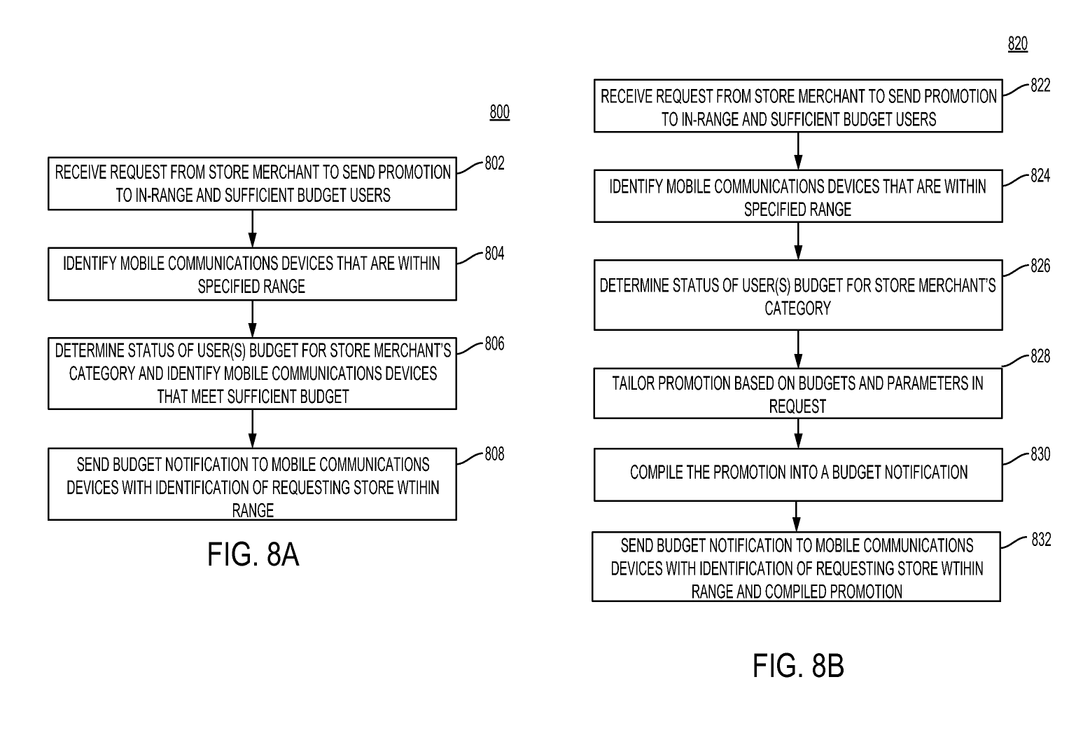

At step 716, the server 108 compiles the promotion based on the promotion parameters received at step 712 and the mobile communications devices 102 identified at step 714. The promotion may be compiled to include one or more specific promotions identified in the parameters received at step 712 (e.g., as discussed in more detail with respect to FIG. 8A below) or dynamically created/modified by negotiation between the server 108 and the requesting store 104 or by the server 108 within the parameters provided by the store 104 (e.g., as discussed in more detail with respect to FIG. 8B below).

Once the promotion has been compiled at step 716, the method 700 proceeds to step 718, where the server 108 determines whether to transmit the budget notification to the mobile communications device 102. This may be, for example, based on the current status of the user's budget for the identified budget category. For example, if the server 108 determines that the user should not be making a purchase of a specific type, item, or from a specific store (e.g., based on the amount of budget remaining in the budget period), any such notifications that ordinarily may be delivered to the user would not be communicated to the mobile communications device 102. Alternatively, the server 108 may still send a budget notification to the mobile communications device 102 indicating that the user should limit purchases to below a certain amount and/or that the user should refrain from any more purchases in that category for the remainder of the budget period. Where there is sufficient budget, the server 108 may determine to send the notification according to any of the embodiments and examples described above.

The method 700 then proceeds to step 720, where the promotion is transmitted to the identified mobile communications devices 102 as part of a budget notification, for example as described in the embodiments above.

Returning to decision step 710, if the server 108 received the request for service from the mobile communications device 102, the method 700 proceeds to step 718 as just described, and then step 720. As described above, at step 720 the server 108 transmits the information, or some subset/summary thereof, to the mobile communications device 102 associated with the user's account.

Returning to decision step 710 again, if the server 108 received the request for service from a payment service provider, the method 700 proceeds to step 722. The payment service provider may be, for example, a provider that the user of the mobile communications device 102 has an account with (e.g. PayPal, a bank credit card, etc.).

At step 722, the server 108 determines whether any communications devices 102 that have provided location information to the server 108 meet any requirements specified in the service request (e.g. are within the specified radius, have an associated budget category and are within the pre-defined percentage of budget).

At step 724, the server 108 generates a purchase incentive for one or more products offered by the store 104 (or, alternatively, a purchase incentive generally intended to induce the user of the mobile communications device 102 to make any purchase at the store 104 for the one or more budget categories).

This purchase incentive may include, for example, an offer to subsidize the purchase of any given product or products (e.g., a specific item or an aggregated number of items whose value together exceeds a threshold), an offer to provide a gift card to the user, or to use some form of loyalty points to subsidize/cover the cost of something purchased from the store 104 at that time. These are just a few examples, as will be recognized there are other possible options that could be offered to the user of the mobile communications device 102 that is within range of the store 104 instead. The purchase incentive may be influenced by the percentage of the budget remaining in the one or more categories corresponding to the store 104, for example by tailoring the purchase incentive to induce the user to make a purchase at the store 104 based on the percentage of the particular budget category for the budget period.

Once the server 108 has generated the purchase incentive at step 724 in response to the service request received at step 702, the method 700 proceeds to step 718 to determine whether to send and step 720, where the generated purchase incentive is transmitted to the mobile communications devices 102 identified at step 722.

Turning now to FIG. 8A, a flow diagram of an embodiment of a method 800 for merchant-requested advertising based on location-based budget alerts is illustrated according to an embodiment of the present disclosure. For example, the method 800 may be performed by server 108. It is understood that additional steps can be provided before, during, and after the steps of method 800, and that some of the steps described can be replaced or eliminated for other embodiments of the method 800.

At step 802, the server 108 receives a request from a store merchant, such as of store 104, to send one or more promotions to mobile communications devices 102 that meet certain criteria, such as being within range (e.g., within a pre-defined radius or one specified in the request) and/or within a sufficient budget (e.g., devices associated with users that have a budget category that corresponds to the store 104 and/or that have a specified threshold amount of budget remaining in the budget period). The request may also include information regarding one or more specific promotions to be included in a budget notification to one or more qualifying mobile communications devices 102.

At step 804, the server 108 identifies any mobile communications devices 102 that are within the specified range, e.g. as illustrated in FIG. 5 as those within the radius 554. These mobile communications devices 102 may be identified as a first set of mobile communications devices 102.

At step 806, the server 108 determines the status of the budgets of users associated with those mobile communications devices 102 that were identified in step 804. The server 108 looks at the budget category(ies) that are associated with the store merchant that originated the request from step 802. After analyzing the status of the budget category for each user associated with the identified mobile communications devices 102, the server 102 identifies one or more mobile communications devices 102 from among the first set that meet one or more budget constraints that were included in the original request at step 802 (or in a subsequent communication during the session). For example, the server 108 may identify those mobile communications devices 102 within range that have more than a specified percentage of budget available in the category in the budget period. These mobile communications devices 102 may be identified as a second set of mobile communications devices 102, which may correspond to or be a subset of the first set.

At step 808, the server 108 sends a budget notification to the second set of mobile communications devices 102 generated at step 806. The budget notification may include information described above with respect to other embodiments, e.g. an identification of the particular budget category, an amount remaining, and a percentage with respect to the total budget and the amount of time (e.g., specified in days) remaining in the budget period. The budget notification includes an identification of the requesting store 104. In one embodiment, the server 108 identifies the requesting store 104 as being close by to the mobile communications device 102 (and may specify the estimated distance).

In a further embodiment, in addition to the budget notification identifying the store 104 that is within the specified range, the budget alert module 314 of the mobile communications device 102 may communicate with a navigation tool, such as is available in some map applications, to either provide directions to via some aspect of the user interface 308 (e.g., combination of visual, audio, and tactile feedback) within the budget alert module 314, or hand off interaction to the navigation tool directly to direct the user to the store 104.

FIG. 8B is a flow diagram illustrating an alternative embodiment to that of method 800 from FIG. 8A above, showing a method 820 for merchant-requested advertising based on location-based budget alerts. For example, the method 820 may be performed by server 108. It is understood that additional steps can be provided before, during, and after the steps of method 820, and that some of the steps described can be replaced or eliminated for other embodiments of the method 820.

At step 822, the server 108 receives a request from a store merchant, such as of store 104, to send one or more promotions to mobile communications devices 102 for example as described above with respect to FIG. 8A at step 802. In addition to the information described from step 802 of FIG. 8A, the request also includes one or more promotion parameters for use in tailoring a promotion to qualifying mobile communications devices 102 identified as described below.

At step 824, the server 108 identifies any mobile communications devices 102 that are within the specified range, e.g. as described above with respect to step 804 of FIG. 8A.

At step 826, the server 108 determines the status of the budgets of users associated with those mobile communications devices 102 that were identified in step 824. The server 108 looks at the budget category(ies) that are associated with the store merchant that originated the request from step 822.

At step 828, the server 108 tailors the promotion to be sent based on one or more the budget status obtained at step 826 for the mobile communications devices 102 identified at step 824 and the parameters included in the request received at step 822. This may otherwise be referred to as dynamically creating or modifying the promotion. For example, in an embodiment the store 104 includes with its request a proposed promotion (e.g., a sale price or discount for a particular product within a budget category). After the server 108 has determined the status of the budgets associated with mobile communications devices 102 that are within the specified range of the store 104, the server 108 may modify the promotion (e.g., increasing the discount or offering a discount for a different product, such as one that is more or less expensive than the suggested product) based on general parameters included with the request. In order to be able to modify the promotion, the server 108 may need to receive an authorization from the store 104 in order to do so.

Where such authorization is not available or provided, the server 108 may identify budgetary constraints that would render the original promotion less effective and send the information back to the store 104. This may be done without identifying specific mobile communications devices 102 (or associated accounts/users) so as to protect the privacy of the users of the mobile communications devices 102. The server 108 may also include a recommended modification that may better entice the user, e.g. to increase a discount or change products. The store 104 may retain decisional authority and, once decided, send an updated promotion to the server 108 for distribution to the identified mobile communications devices 102.

At step 830, once the promotion has been decided upon (including modifications, etc.) the server 108 compiles the promotion based on the result of step 828.

At step 832, the server 108 transmits the budget notification to the mobile communications devices 102 identified at step 824 (and, in embodiments, that were narrowed down at steps 826 and 828 based on available budget), for example as described with respect to step 808 of FIG. 8A above.

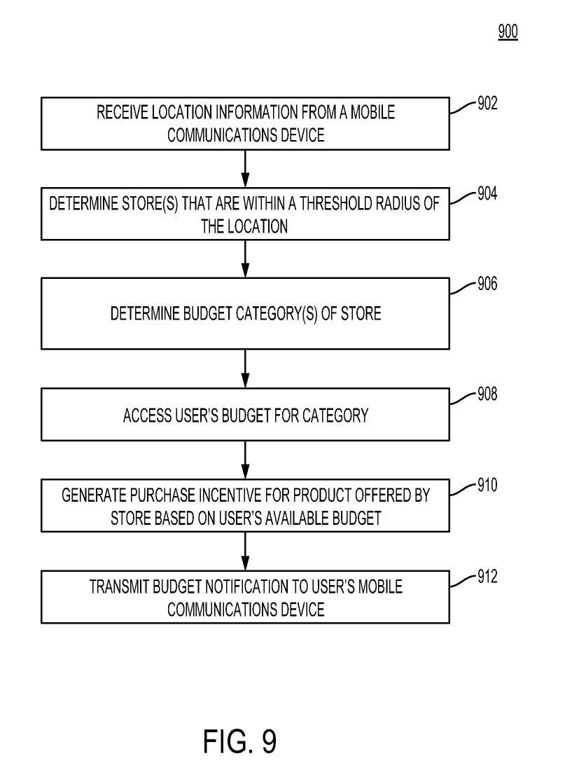

FIG. 9 is a flow diagram illustrating an embodiment of a method 900 for payment service provider location-based budget alerts according to an embodiment of the present disclosure. It is understood that additional steps can be provided before, during, and after the steps of method 900, and that some of the steps described can be replaced or eliminated for other embodiments of the method 900. In an embodiment, the payment service provider may be operated by the same entity that operates the server 108, and/or may be integrated with the server 108.

At step 902, the server 108 receives location information from a mobile communications device 102. The location information may be, for example, GPS location data that the server 108 receives via transceiver 202 as generated by the mobile communications device 102 in communication with a GNSS 110.

At step 904, the server 108 locates one or more stores (e.g., store 104 as illustrated in the examples above) that are within a predetermined vicinity of the mobile communications device 102's current location (e.g., illustrated as vicinity 112 in FIG. 4 above) as described above in step 604 of FIG. 6A.

At step 906, the server 108 (for example, using budget alert module 210) determines one or more budget categories associated with each store 104 located at step 904.

At step 908, the server 108 then checks whether the user associated with the mobile communications device 102 has created a category in their budget particular to the budget category associated with the store 104 and access the budget category to determine a status.

At step 910, the server 108 generates one or more purchase incentives for one or more products offered by the store (or, alternatively, a purchase incentive generally intended to induce the user of the mobile communications device 102 to make any purchase at the store 104 for the one or more budget categories). As described above with respect to FIG. 7, this purchase incentive may include, for example, an offer to subsidize the purchase of any given product or products, an offer to provide a gift card to the user, or to use some form of loyalty points to subsidize/cover the cost of something purchased from the store 104 at that time. The purchase incentive may be influenced by the percentage of the budget remaining in the one or more categories corresponding to the store 104, for example by tailoring the purchase incentive to induce the user to make a purchase at the store 104 based on the percentage of the particular budget category for the budget period.

Once the server 108 has generated the purchase incentive at step 912 the generated purchase incentive is transmitted to the mobile communications device 102 as part of a budget notification. As a result, the server 108 sends a personalized budget alert to the mobile communications device 102 before the mobile communications device 102 reaches a point of sale to initiate or complete a purchase transaction, and may be induced by the generated incentive to enter the store 104 and/or initiate a purchase at the store 104.

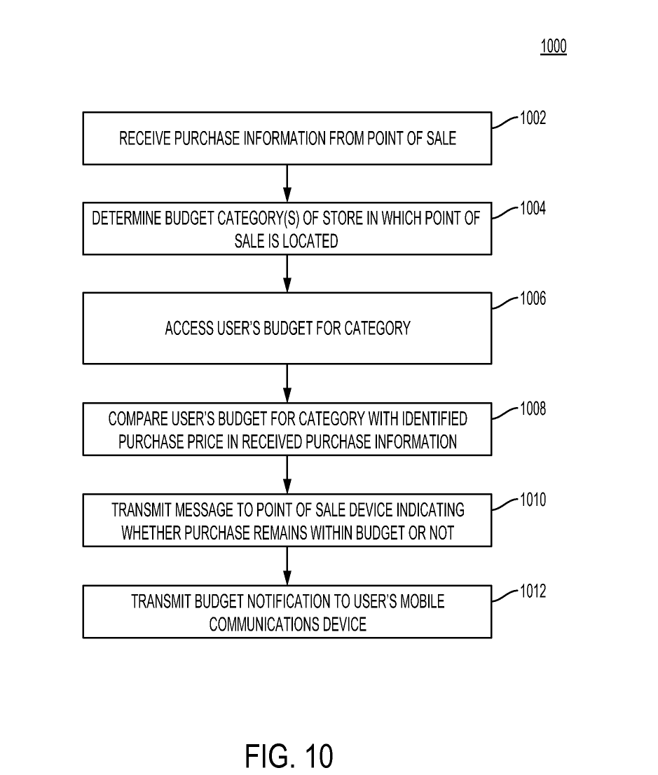

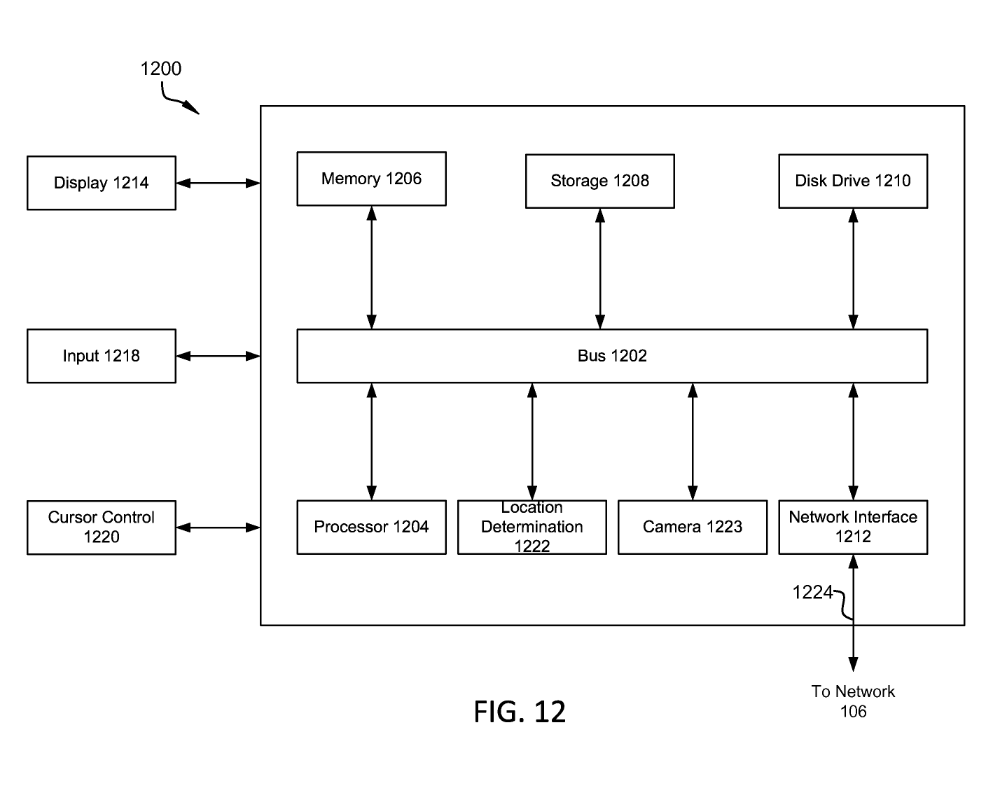

FIG. 10 is a flow diagram illustrating an embodiment of a method 1000 for payment processor location-based budget alerts according to an embodiment of the present disclosure. It is understood that additional steps can be provided before, during, and after the steps of method 1000, and that some of the steps described can be replaced or eliminated for other embodiments of the method 1000. The method 1000 may take place, for example, at the server 108 that is in communication with a point of sale device that may include one or more aspects of the computer system illustrated in FIG. 12.

At step 1002, the server 108 receives purchase information from a point of sale device. This occurs where a user (e.g., someone who has an account that is maintained by the server 108 such as by the budget alert module 210 for budget notifications) initiates a transaction at the point of sale associated with a store 104. In an embodiment, the server 108 is part of a payment service provider, as described above with respect to FIG. 9, and therefore when a purchase transaction is initiated the payment service provider is able to check the user's budget status before completing the transaction. The purchase information may include, for example, a price of each product in the transaction, an identification of the store 104, and a location of the store 104. Further, the location information may be explicitly identified in the purchase information message or be determined by the server 108 based on information associated with the store 104 and a check to another database internally or externally.

In an embodiment, the server 108 may additionally receive location information from a mobile communications device 102 associated with the user attempting the purchase transaction (either automatically or in response to a request from the server 108). The server 108 may compare the location of the mobile communications device 102 to the location information included or derived from the purchase information message from the point of sale device. The server 108 may instruct the transaction to be denied where the locations of the two are not within a predetermined threshold distance of each other, or alternatively may initiate an out of band confirmation with the mobile communications device 102 to confirm the transaction attempt, e.g. when the purchase amount is above a threshold or above a certain percentage of the budget for the budget period.

At step 1004, the server 108 determines one or more budget categories associated with the store 104 and/or the products/services specifically. The one or more budget categories of the store 104 and/or products/services in the purchase transaction may be explicitly identified in the purchase information message or alternatively may be determined by the server 108 based on the type of store 104 and/or types of products being purchased.

At step 1006, the server 108 accesses the user's budget for the budget category. This may include, for example, accessing an amount available still in the budget, a comparison to the overall budget (e.g. calculation of a percentage), and how much time is left in the budget period. In an embodiment, this may also involve checking whether the user associated with the mobile communications device 102 has created a category in their budget particular to the budget category associated with the store 104. If not, then the server 108 may, in embodiments, alternatively turn to a miscellaneous or general category instead.

At step 1008, the server 108 compares the price in the purchase information with the budget amount of the budget category identified at step 1006.

At step 1010, the server 108 transmits the results of the comparison at step 1008 to the point of sale device. The results may include, for example, a message indicating whether the purchase, if completed, would cause the user to exceed the specified budget amount for the given budget period. The results could also include an instruction to cause the point of sale device to request an additional confirmation from the user before completing the transaction when the purchase would cause the budget to be exceeded (or reach a pre-specified percentage of total budget threshold). In an embodiment, the results could also include instructions to have the point of sale device display the remaining budget, percentage remaining, budget impact, etc. to the user. In another embodiment, this may not be included or displayed so as to protect the privacy of the user.

At step 1012, the server 108 transmits a budget notification to the mobile communications device 102 associated with the user. This may be done, for example, approximately concurrently with the results transmitted to the point of sale device in step 1010. The budget notification may include some or all of the information determined in the previous steps, including for example specific budget information that may be considered too personal for a point of sale device that others may see, for example total budget amount, percentage used, and amount of time remaining in the budget period.

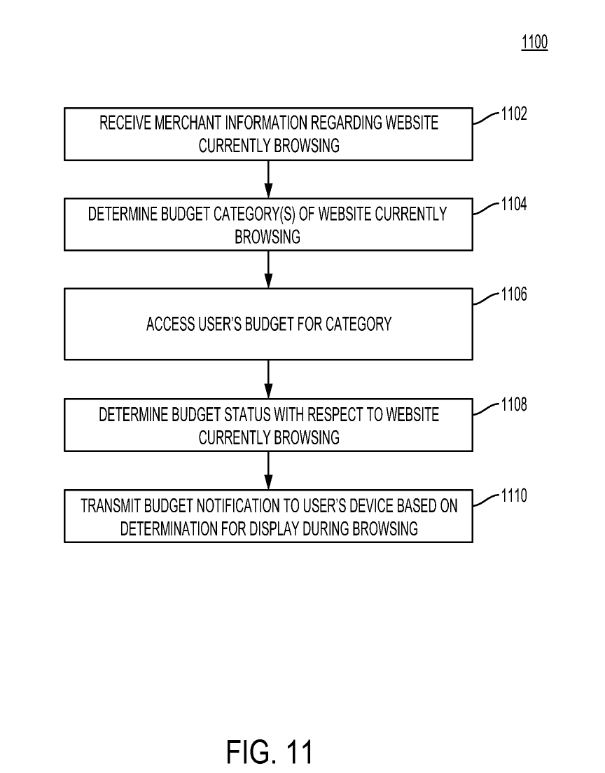

In the embodiments above, the focus has been on the interaction of budget notifications with a mobile communications device 102, prior to initiating or completing a purchase transaction. Embodiments of the present disclosure may also apply in scenarios where a user (e.g., a subscriber of the budget notification service who maintains an account through the server 108) is browsing one or more merchants' web pages with an access device (which may be a mobile communications device or some other type of device capable of accessing a network on which the websites are hosted). One example is illustrated with respect to FIG. 11.

FIG. 11 is a flow diagram illustrating an embodiment of a method 1100 for online location-based browsing budget alerts according to an embodiment of the present disclosure. It is understood that additional steps can be provided before, during, and after the steps of method 1100, and that some of the steps described can be replaced or eliminated for other embodiments of the method 1100. The user may maintain an account with the server 108 where the user tracks budget expenditures and receives notifications as described in the steps below. The budgets may be set and maintained locally at the server 108 (e.g., via a web interface with the user) or may be imported from a third party system as discussed in embodiments above. The method 1100 may take place, for example, at the server 108 that is in communication with a browsing device in use by the user that may include one or more aspects of the computer system illustrated in FIG. 12.

At step 1102, the server 108 receives merchant information regarding the website that the user is currently browsing. The merchant information may include, for example, the merchant name, merchant type, products currently displayed on the web page and/or products generally offered by the merchant, and a location of the merchant if known, to name just a few examples. Other data or metadata may be included as well.

At step 1104, the server 108 determines one or more budget categories associated with the merchant identified and/or the products/services specifically. The one or more budget categories of the merchant and/or products/services identified from the website may be explicitly identified in metadata received at step 1102 or alternatively may be determined by the server 108 based on the type of merchant and/or types of products being purchased.

At step 1106, the server 108 accesses the user's budget for the budget category. This may include, for example, accessing an amount available still in the budget, a comparison to the overall budget (e.g. calculation of a percentage), and how much time is left in the budget period. In an embodiment, this may also involve checking whether the user associated with the mobile communications device 102 has created a category in their budget particular to the budget category associated with the merchant. If not, then the server 108 may, in embodiments, alternatively turn to a miscellaneous or general category instead.

At step 1108, the server 108 determines the status of the budget category of the merchant for the user—e.g., an amount available still in the budget, a comparison to the overall budget (e.g. calculation of a percentage), and how much time is left in the budget period, to name just a few examples.

At step 1110, the server 108 takes the information determined at step 1108 and transmits the information, or some subset/summary thereof, to the browsing device currently being used by the server. This may be enabled, for example, because the user has logged in to a service at the browsing device that runs in the background while the user browses one or more webpages. This information is transmitted as a budget notification that is displayed during browsing. The budget notification includes some or all of the information determined in the previous steps. The budget notification may be displayed as a pop-up window during the browsing session, as an inline message in some field reserved in the webpage for that purpose, and/or as a message sent to one or more other devices (such as mobile communications device 102) that is registered with the account associated with the user at the server 108. As a result, the server 108 sends a personalized budget alert to the browsing device when accessing a merchant's webpage, before initiating or completing a purchase transaction.

Referring now to FIG. 12 an embodiment of a computer system 1200 suitable for implementing, for example, the mobile communications devices, servers, point of sale devices, browsing devices, etc., is illustrated. It should be appreciated that other devices utilized by users, payment service providers, point of sale operators, and/or merchants/stores in the system discussed above may be implemented as the computer system 1200 in a manner as follows.

In accordance with various embodiments of the present disclosure, computer system 1200, such as a computer and/or a network server, includes a bus 1202 or other communication mechanism for communicating information, which interconnects subsystems and components, such as a processing component 1204 (e.g., processor, micro-controller, digital signal processor (DSP), etc.), a system memory component 1206 (e.g., RAM), a static storage component 1208 (e.g., ROM), a disk drive component 1210 (e.g., magnetic or optical), a network interface component 1212 (e.g., modem or Ethernet card), a display component 1214 (e.g., CRT or LCD), an input component 1218 (e.g., keyboard, keypad, or virtual keyboard), a cursor control component 1220 (e.g., mouse, pointer, or trackball), a location determination component 1222 (e.g., a Global Positioning System (GPS) device as illustrated, a cell tower triangulation device, and/or a variety of other location determination devices known in the art), and/or a camera component 1223. In one implementation, the disk drive component 1210 may comprise a database having one or more disk drive components.

In accordance with embodiments of the present disclosure, the computer system 1200 performs specific operations by the processor 1204 executing one or more sequences of instructions contained in the memory component 1206, such as described herein with respect to the customer devices, merchant devices, payment service provider device, and/or process modeling device. Such instructions may be read into the system memory component 1206 from another computer readable medium, such as the static storage component 1208 or the disk drive component 1210. In other embodiments, hard-wired circuitry may be used in place of or in combination with software instructions to implement the present disclosure.

Logic may be encoded in a computer readable medium, which may refer to any medium that participates in providing instructions to the processor 1204 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1210, volatile media includes dynamic memory, such as the system memory component 1206, and transmission media includes coaxial cables, copper wire, and fiber optics, including wires that comprise the bus 1202. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1200. In various other embodiments of the present disclosure, a plurality of the computer systems 1200 coupled by a communication link 1224 to the network 106 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1200 may transmit and receive messages, data, information and instructions, including one or more programs (i.e., application code) through the communication link 1224 and the network interface component 1212. The network interface component 1212 may include an antenna, either separate or integrated, to enable transmission and reception via the communication link 1224. Received program code may be executed by processor 1204 as received and/or stored in disk drive component 1210 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for providing location-based budget alerts, comprising:
a communications interface coupled to a communications network; and
a computing resource coupled to the communications interface, wherein the computing resource is configured to:
receive, from a mobile communications device via the communications interface, location information of the mobile communications device;
determine at least one store that is within a determined vicinity of the mobile communications device based on the received location information;
access an account associated with the mobile communications device, the account comprising budget information for a user of the account; and
determine whether to transmit a notification to the mobile communications device based on the budget information accessed in the account and information about the at least one store within the determined vicinity.

2. The system of claim 1, wherein the computing resource is further configured to:
determine at least one budget category associated with the at least one store, wherein the budget information of the account comprises a maximum amount for a fixed budget period for a budget associated with the at least one determined budget category; and
transmit the notification to the mobile communications device in response to determining to transmit the notification based on the budget information and the information about the at least one store, the notification comprising a status of the budget associated with the at least one budget category, wherein the status comprises an identification of a percentage of the maximum amount with respect to an amount of time remaining in the fixed budget period.

3. The system of claim 2, wherein the system is part of a payment service provider, the computing resource being further configured to:
generate a purchase incentive for a product offered by the at least one store in response to an amount of the percentage.

4. The system of claim 1, further comprising:
a database configured to store a plurality of user accounts including the account associated with the mobile communications device.

5. The system of claim 1, wherein the computing resource is further configured to:
receive, from a server associated with a merchant via the communications interface, an advertising request to share a promotion with one or more mobile communications devices within a predetermined area of the merchant that have a predetermined budget amount remaining in at least one identified budget category associated with the merchant;
determine one or more mobile communications devices, from among a plurality of mobile communications devices with associated accounts, that are within the predetermined area of the merchant based on the received location information from each mobile communications device, and that have the predetermined budget amount remaining in the at least one identified budget category associated with the merchant; and
transmit the promotion to the determined one or more mobile communications devices on behalf of the merchant.

6. The system of claim 5, wherein the computing resource is further configured to:
receive, as part of the advertising request, one or more promotion parameter ranges acceptable to the merchant; and
compile, based on the one or more promotion parameter ranges and the available budgets of the accounts associated with the plurality of mobile communications devices, the promotion that is transmitted to the determined one or more mobile communications devices on behalf of the merchant.

7. The system of claim 1, wherein the computing resource is further configured to transmit the notification to the mobile communications device each time that location information received from the mobile communications device indicates that the store is within the threshold radius of the mobile communications device.

8. A method for providing location-based notifications at a server, comprising:
receiving, from a mobile communications device, location information of the mobile communications device;
determining at least one store that is within a determined vicinity of the mobile communications device based on the received location information;
accessing an account associated with the mobile communications device, the account comprising budget information for a user of the account; and
determining, by the server, whether to transmit a notification to the mobile communications device based on the budget information accessed in the account and information about the at least one store within the determined vicinity.

9. The method of claim 8, further comprising:
determining at least one budget category associated with the at least one store, wherein the at least one budget category comprises a maximum amount for a fixed budget period;
determining a percentage of the maximum amount with respect to an amount of time remaining in the fixed budget period, the determined percentage comprising a status of the at least one budget category; and
transmitting the notification to the mobile communications device in response to determining to transmit the notification based on the budget information and the information about the at least one store, the notification comprising the status.

10. The method of claim 9, further comprising:
generating a purchase incentive for a product offered by the at least one store in response to an amount of the percentage.

11. The method of claim 8, further comprising:
storing a plurality of user accounts including the account associated with the mobile communications device in a database.

12. The method of claim 8, further comprising:
receiving, from a server associated with a merchant, an advertising request to share a promotion with one or more mobile communications devices within a predetermined area of the merchant that have a predetermined budget amount remaining in at least one identified budget category associated with the merchant;
determining one or more mobile communications devices, from among a plurality of mobile communications devices with associated accounts, that are within the predetermined area of the merchant based on the received location information from each mobile communications device, and that have the predetermined budget amount remaining in the at least one identified budget category associated with the merchant; and
transmitting the promotion to the determined one or more mobile communications devices on behalf of the merchant.

13. The method of claim 12, further comprising:
receiving, as part of the advertising request, one or more promotion parameter ranges acceptable to the merchant; and
compiling, based on the one or more promotion parameter ranges and the available budgets of the accounts associated with the plurality of mobile communications devices, the promotion that is transmitted to the determined one or more mobile communications devices on behalf of the merchant.

14. The system of claim 8, wherein the transmitting further comprises:
transmitting the notification to the mobile communications device each time that location information received from the mobile communications device indicates that the store is within the threshold radius of the mobile communications device.

15. A non-transitory computer-readable medium comprising instructions which, in response to execution by a computer system, cause the computer system to perform a method comprising:
receiving, from a mobile communications device, location information of the mobile communications device;
determining at least one store that is within a determined vicinity of the mobile communications device based on the received location information;
accessing an account associated with the mobile communications device, the account comprising budget information for a user of the account; and
determining whether to transmit a notification to the mobile communications device based on the budget information accessed in the account and information about the at least one store within the determined vicinity.

16. The non-transitory machine-readable medium of claim 15, wherein the method further comprises:
determining at least one budget category associated with the at least one store, wherein the at least one budget category comprises a maximum amount for a fixed budget period;
determining a percentage of the maximum amount with respect to an amount of time remaining in the fixed budget period, the determined percentage comprising a status of the at least one budget category; and
transmitting the notification to the mobile communications device in response to determining to transmit the notification based on the budget information and the information about the at least one store, the notification comprising the status.

17. The non-transitory machine-readable medium of claim 16, wherein the method further comprises:
generating a purchase incentive for a product offered by the at least one store in response to an amount of the percentage.

18. The non-transitory machine-readable medium of claim 15, wherein the method further comprises:
receiving, from a server associated with a merchant, an advertising request to share a promotion with one or more mobile communications devices within a predetermined area of the merchant that have a predetermined budget amount remaining in at least one identified budget category associated with the merchant;
determining one or more mobile communications devices, from among a plurality of mobile communications devices with associated accounts, that are within the predetermined area of the merchant based on the received location information from each mobile communications device, and that have the predetermined budget amount remaining in the at least one identified budget category associated with the merchant; and
transmitting the promotion to the determined one or more mobile communications devices on behalf of the merchant.

19. The method of claim 18, further comprising:
receiving, as part of the advertising request, one or more promotion parameter ranges acceptable to the merchant; and
compiling, based on the one or more promotion parameter ranges and the available budgets of the accounts associated with the plurality of mobile communications devices, the promotion that is transmitted to the determined one or more mobile communications devices on behalf of the merchant.

20. The non-transitory machine-readable medium of claim 15, wherein the method further comprises:
transmitting the notification to the mobile communications device each time that location information received from the mobile communications device indicates that the store is within the threshold radius of the mobile communications device.
